(19) United States
(12) Patent Application Publication
(10) Pub. No.: US 2023/0046901 A1
(43) Pub. Date: Feb. 16, 2023

(54) BLOCKCHAIN BASED LAYER 2 APPLICATION FOR DELEGATED OFF-CHAIN PAYMENTS USING CRYPTOCURRENCIES

(71) Applicant: NEC Laboratories Europe GmbH, Heidelberg (DE)

(72) Inventors: Sebastien Andreina, Heidelberg (DE); Maja Schwarz, Heidelberg (DE); Ghassan Karame, Heidelberg (DE)

(21) Appl. No.: 17/503,388

(22) Filed: Oct. 18, 2021

Related U.S. Application Data
(60) Provisional application No. 63/232,669, filed on Aug. 13, 2021.

(51) Int. Cl. G06Q 20/38; G06Q 20/06; G06Q 20/40

(52) U.S. Cl. CPC G06Q 20/3829; G06Q 20/065; G06Q 20/401; G06Q 2220/00

(57) ABSTRACT

A method for securing a cryptocurrency transaction on a permissioned blockchain, which involves cryptocurrencies of a permissionless public blockchain, includes receiving a join request including a transaction identification. The transaction identification identifies an enroll transaction involving a public smart contract deployed on the permissionless public blockchain, the enroll transaction identifying a permissioned blockchain public key being valid on the permissioned blockchain and transferring a cryptocurrency balance to the public smart contract. The method further includes verifying that the enroll transaction was properly executed, crediting an account corresponding to the permissioned blockchain public key with the cryptocurrency balance, and receiving a send request identifying a second cryptocurrency balance and a second permissioned blockchain public key being valid on the permissioned blockchain. The method also includes transferring the second cryptocurrency balance from the permissioned blockchain public key to the second permissioned blockchain public key.

### CROSS-REFERENCE TO RELATED APPLICATION

Priority is claimed to U.S. Provisional Patent Application No. 63/232,669, filed on Aug. 13, 2021, the entire disclosure of which is hereby incorporated by reference herein.

### FIELD

The present invention relates to a method, system and computer-readable medium for a blockchain based, layer 2 application for delegated off-chain payments using cryptocurrencies.

### BACKGROUND

While cryptocurrencies remain the most common use case for blockchain, they are mainly suitable for public and permissionless blockchains. A variety of more complex use cases can be readily implemented via private blockchains. However, private blockchains lack a default currency. Therefore, while creating a private blockchain is straightforward, it is not as easy to ensure their worth.

### SUMMARY

In an embodiment, the present disclosure provides a method for securing a cryptocurrency transaction on a permissioned blockchain. The cryptocurrency transaction involves cryptocurrencies of a permissionless public blockchain. The method includes receiving a join request including a transaction identification. The transaction identification identifies an enroll transaction involving a public smart contract deployed on the permissionless public blockchain, the enroll transaction identifying a permissioned blockchain public key being valid on the permissioned blockchain and transferring a cryptocurrency balance to the public smart contract. The method further includes verifying that the enroll transaction was properly executed, crediting an account corresponding to the permissioned blockchain public key with the cryptocurrency balance, and receiving a send request identifying a second cryptocurrency balance and a second permissioned blockchain public key being valid on the permissioned blockchain. In addition, the method includes transferring the second cryptocurrency balance from the account corresponding to the permissioned blockchain public key to a second account corresponding to the second permissioned blockchain public key.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a workflow according to the present disclosure;

FIG. 2 illustrates a method, implemented by a permissioned private blockchain, for conducting delegated off-chain payments using cryptocurrencies of a permissionless public blockchain; and

FIG. 3 illustrates a processing system.

### DETAILED DESCRIPTION

The present inventors have recognized that private blockchains would benefit from having the possibility of dealing directly with existing cryptocurrencies and to use existing cryptocurrencies to pay for or exchange services inside the private blockchain without requiring, in each instance, a transaction with an existing cryptocurrency.

The present disclosure provides a mechanism that enables the use of coins from public cryptocurrencies for transactions on a private blockchain. Such mechanism provides higher efficiency and lower latency for users, while enabling secure payment on an existing private blockchain.

The present disclosure provides a fully-automated mechanism of transferring tokens between blockchains, which is absent from the state of the art (e.g., those based on custody services). In contrast to state of the art solutions—which require reliance on un-trusted third parties, the fully-automated mechanism provided by the present disclosure for transferring tokens between blockchains also maintains the trust and security benefits of blockchain-based solutions. Apart from the present disclosure, there are no other known solutions that allow a permissioned (i.e. private) blockchain to spend actual currency hosted on another permissionless (i.e. public) blockchain.

The transfer of tokens from a private blockchain to a public blockchain, as provided by the present disclosure, utilizes Byzantine Fault Tolerant (BFT) proofs—and verification of the validity of such proofs—to ensure that the transfer of tokens between the blockchains adheres to strict security requirements. In this manner, the present disclosure improves the security with which inter-blockchain transfers of cryptocurrency ownership can be executed. Furthermore, by utilizing consensus protocols of a permissioned, private blockchain to generate such BFT proofs, the present disclosure reduces latency associated with inter-blockchain transfers of cryptocurrency ownership and can thereby increase the throughput of cryptocurrency-based transactions. In particular, by enabling intra-blockchain transfers, on a private blockchain, of public blockchain cryptocurrencies, the subject matter of the present disclosure provides for transfer of public blockchain cryptocurrencies with increased throughput, lower latency, and at lower cost than transferring such cryptocurrencies directly on a public blockchain. Therefore, the present disclosure enhances both the functionality and security of blockchain transactions—particularly transactions that involve multiple different blockchains.

According to aspects of the present disclosure, coins of existing cryptocurrencies can be securely exported to a private blockchain, thereby enabling users of the private blockchain to transact using the coins of the existing cryptocurrencies without sending the transactions to the cryptocurrency blockchain for verification. Unlike off-chain side-channel payments (such as Lightning Network for bitcoin), in present disclosure, payments are not limited to channels (e.g., between only 2 participants). Instead, aspects of the present disclosure allow all of the participants of the private blockchain to transact together. An advantage of aspects of the present disclosure is that the coins used keep their worth because participants are allowed at any time to “cash-out” and retrieve their coins on the original cryptocurrency blockchain.

A further embodiment could envision a lending use case in which a cryptocurrency loan is secured with collateral in the form of tokens. A borrower could provide tokens, such as tokens representing (fractional) ownership in fine art, as a guarantee that the loan will be paid back. In this case the tokens are issued on a permissioned blockchain, while the cryptocurrency loan is given on a permissionless blockchain on which the cryptocurrency issued. A smart contract on the permissioned blockchain and another one on the permissionless blockchain can then use the protocol described in this application to manage the loan and collateral. The smart contract on the permissioned blockchain is used to block the tokens provided as the collateral, and the smart contract on the permissionless blockchain checks that the loan payments are transferred and acknowledges when the loan is fully repaid in order to return the tokens to the borrower. In case of a default on loan, the tokens are transferred to the lender by transferring them to the public key that the lender provided on the permissioned blockchain.

The present disclosure provides fast and secure payment on a permissioned (e.g., Byzantine Fault Tolerance (BFT)-based) blockchain using cryptocurrency coins from an existing public blockchain, such as the Ethereum blockchain. According to aspects of the present disclosure, the existing public blockchain supports smart contract. A smart contract is a computer program or transaction protocol that is configured to automatically execute and operate on the blockchain. Specifically, a smart contract is a processor-executable program (code) stored on a non-transitory processor readable medium that, when executed by processor, causes the processor to carry out program functions. The code is available (i.e. can be inspected) to all the members present on the network. A person of ordinary skill in the art would recognize that a “smart contract” is a technical aspect of blockchain networks used for automation, and not a legal instrument or other means of constraining human activity.

Some advantages of the present disclosure include a tremendous reduction in latency (i.e., a few seconds vs hours) and lower fees (because the private chain is not running the expensive proof-of-work but an efficient and secure BFT algorithm) that accompany the execution of transactions on a the private blockchain as compared to the execution of transactions on a public blockchain. Such advantages stem from the use of an efficient and secure BFT algorithm for verifying transactions and establishing consensus on the private chai—as compared to an expensive proof-of-work algorithm used by the public blockchain.

Aspects of the present disclosure utilize: 1) a Simplified Payment Verification (SPV) client; and 2) BFT proofs. In a preferred embodiment of the present disclosure, user funds are locked on the public cryptocurrency blockchain (i.e. the public chain) through a smart contract, and unlocked on the private BFT-based blockchain (i.e. the private chain) to allow users to conduct transactions on the private chain. When a user of the private chain wants to cash out, the user requests a BFT proof that the user is cashing out, and the user can claim the coins back via the smart contract on the public chain.

An SPV client is a lightweight software program able to verify, up to a certain degree of security, that a payment has been made on a public chain based on proof-of-work (PoW) (such public chains include the Bitcoin and Ethereum blockchains, and many others). The SPV client achieves this result without having to download the full history of the blockchain and is therefore suitable for resource-constrained devices (e.g. mobile phones).

The SPV client typically verifies that a payment has been made on the public chain by requesting that multiple nodes of the public chain retrieve information about a transaction having a particular transaction identification (TxID). The nodes then reply with a series of block headers (that are very small) and a proof to show that the transaction with the TxID is included in one of those headers. This can be done by revealing the part of the Merkle tree whose root is stored in the header that contains the transaction. The SPV client requests multiple headers to make sure that the transaction is in a block that is indeed part of the public chain, and not in a block that has been maliciously crafted/removed from the public chain due to a fork.

The method implemented by the SPV client for verification of a transaction is secure as long as the adversary cannot break the Merkle tree security (which relies on hash function hardness) and is not able to produce sufficiently many block headers rapidly. Those assumptions are fair because they are consistent with the assumptions upon which PoW blockchains are based. Specifically, if an adversary could break the hash function used, then the whole PoW blockchain ecosystem would be broken, and if the adversary could generate sufficiently many block headers, then the adversary would possess more mining power than the majority, which goes against the assumptions of PoW blockchains.

A Byzantine Fault Tolerance (BFT) proof is a proof that shows that a quorum of nodes running a BFT algorithm agrees on some value/truth. The quorum can be, for example, a simple majority (i.e. more than n/2 nodes) or a super majority (i.e. at least ⅔ nodes). Agreement by a quorum of nodes can be demonstrated by collecting a number, required for the quorum, of signatures over the statement to agree on, where each respective node agrees to sign only if the statement is evaluated, locally by the respective node, to true. Verifying a BFT proof requires access to the configuration information of the BFT setup, such as the number of potentially malicious nodes, the total number of nodes, and their public keys. A proof can be written as:

π<[statement arguments],quorum signature>.

Aspects of the present disclosure use a private blockchain—which provides advantages such as low transaction costs and high throughput/low latency—to execute transactions in an existing cryptocurrency. Aspects of the present disclosure can be seen as layer-2 solutions using a blockchain, that enable high efficiency trading between users of assets generated and held on another (less efficient/slower) blockchain.

Aspects of the present disclosure include two main functions for interactions between a private chain and a public chain: 1) enroll, which will transfer coins held by a user on the public chain to the private chain; and 2) cash out, which will transfer all coins held by the user on the private chain back to the public chain handling the cryptocurrency.

According to aspects of the present disclosure, an architecture is provided with one (or multiple) public cryptocurrency blockchain(s) that support generic smart contracts, and one private blockchain. The public cryptocurrency blockchain is defined as B_{c}, and the private blockchain is defined as Bₚ. The public chain B_{c} has a default coin c and provides support for smart contracts s. The public chain B_{c} provides an SPV client that is able to verify transactions on the public chain B_{c} without downloading the full public chain.

In an embodiment, a smart contract is instantiated on both the public chain and the private chain: a public smart contract s_{c} on the public blockchain B_{c} and a private smart contract sₚ on the private blockchain Bₚ. The public smart contract s_{c} is used to facilitate the technical transfer of coins c between the public chain B_{c} and the private chain Bₚ, while the private smart contract sₚ provides all the normal asset exchange functions on the private chain Bₚ. For security reasons, the private smart contract sₚ on the private blockchain Bₚ creates the deploy transaction of the public smart contract s_{c} on the public chain B_{c} and will only accept Enroll transactions that are sent to the public smart contract s_{c}. This ensures that the coins sent to the public smart contract s_{c} are handled as expected.

The public smart contract s_{c} provides only the following two functions:

1. Enroll(X coins, key)

2. Cashout(π)

The Enroll function takes as input some coins and a public key keyₚ. The key keyₚ is a valid public key on the private chain Bₚ and does not need to be valid on the public chain B_{c}. The Enroll function adds the X coins taken as input to the account of the smart contract s_{c}. After the Enroll step, the original owner of the coins on the public chain B_{c}. cannot take back ownership of the coins on the public chain B_{c}. without a proof π from the private chain Bₚ.

A call to Cashout(π) with a valid proof will return coins held by the smart contract s_{c}. to an address of a public key key_{c} (i.e. a valid public key on the public chain Bₚ) encoded inside the proof π—which is a BFT-proof as defined herein. The proof π contains an amount of coins to withdraw from the smart contract s_{c}, the public key key_{c} to which the coins should go and last, the BFT-proof that the information is correct.

The Cashout function is the only way to transfer coins from the public smart contract s_{c}. And, without a proper BFT proof, it is not possible to transfer coins from the public smart contract s_{c} to another address on the public chain B_{c}.

The private smart contract sₚ provides virtualized coins on the private chain Bₚ that represent coins of the existing cryptocurrency on the public chain B_{c}. The virtualized coins on the private chain Bₚ are backed by actual coins of the existing cryptocurrency held by the public smart contract s_{c} on the public chain B_{c}. This enables permissioned users of the private chain Bₚ to transact, with low fees and latency on the private chain Bₚ, in coins on the public chain B_{c}. The private smart contract also enables permissioned users of the private chain Bₚ to as exchange coins₁ on a first public chain B_{c1} for coins₂ on a second public chain B_{c2}. The private smart contract sₚ therefore keeps track, on the private chain Bₚ, of the amount and type of coins/assets owned by each permissioned user of the private chain Bₚ.

The private smart contract sₚ provides at least the following 3 functions:

1. Join(TxID)

2. Quit(key)

3. Send (Coins, key)

The first function Join takes as input a transaction identification TxID of the Enroll transaction on the B_{c}. The private smart contract sₚ will then run the SPV client to verify the validity of the Enroll transaction. If the SPV confirms the Enroll transaction, the private smart contract sₚ credits X coins to the public key keyₚ on the private chain Bₚ (where the X coins and the public key keyₚ on the private chain Bₚ were provided as inputs to the Enroll transaction).

The Quit(key) function simply deletes the account of the public key keyₚ on the private chain Bₚ and creates a BFT proof π that the coins currently held by the public key keyₚ on the private chain Bₚ should be sent to the public key key_{c} on the public chain B_{c}.

The Send(coins, key) function enables transactions between different permissioned users of the private chain Bₚ. The function Send takes as input some coins and a public key keyₚ and credits the coins to the public key keyₚ on the private chain Bₚ.

An embodiment of the present disclosure provides a method for carrying out cryptocurrency transactions on a permissioned blockchain. The cryptocurrency transactions involving cryptocurrencies of a permissionless public blockchain. The method includes instantiating a private smart contract on the permissioned blockchain and receiving, by the private smart contract, a join request including a transaction identification. The transaction identification identifies an enroll transaction involving a public smart contract deployed on the permissionless public blockchain. The enroll transaction identifies a permissioned blockchain public key being valid on the permissioned blockchain and transfers a cryptocurrency balance to the public smart contract. The method further includes verifying, by the private smart contract, that the enroll transaction was properly executed, crediting, by the private smart contract, an account corresponding to the permissioned blockchain public key with the cryptocurrency balance, and receiving, by the private smart contract, a send request. The send request identifies a second cryptocurrency balance and a second permissioned blockchain public key being valid on the permissioned blockchain. The method additionally includes transferring, by the private smart contract, the second cryptocurrency balance from the account corresponding to the permissioned blockchain public key to a second account corresponding to the second permissioned blockchain public key. The private smart contract is set of processor-executable program stored on a non-transitory processor readable medium that, when executed by processor, causes the processor to carry out program functions.

The method can further include deploying, by the permissioned blockchain, the public smart contract in the permissionless public blockchain. The method can also additionally include receiving, by the private smart contract, a withdraw request identifying a permissionless blockchain public key, the withdraw request including a signature using a secret key of a public-private key pair corresponding to the second permissioned blockchain public key, and computing, by the permissioned blockchain, a proof including a third cryptocurrency balance, the permissionless blockchain public key, and a signature of a valid quorum of nodes of the permissioned blockchain.

The proof can be a Byzantine fault tolerance (BFT) proof and the public smart contract can be configured to evaluate the validity of the BFT proof. The method can additionally include transmitting, by the private smart contract to the public smart contract, BFT configuration parameters, the BFT configuration parameters being used by the public smart contract to evaluate the validity of the BFT proof. The method can further include updating, by the private smart contract, the BFT configuration parameters in response to an increase or decrease in a total number of nodes of the permissioned blockchain and/or a number of nodes of the permissioned blockchain required for a quorum. Updating the BFT configuration parameters can include transmitting, by the private smart contract to the public smart contract, a cryptographic accumulator that includes a set of currently valid keys of all nodes of the permissioned blockchain, wherein the cryptographic accumulator is signed by a valid quorum of nodes of a previous configuration of the permissioned blockchain.

The verifying, by the private smart contract, that the enroll transaction was properly executed can include invoking a simplified payment verification (SPV) client to retrieve information corresponding to the transaction identification. The SPV client is configured to request, from each of multiple public nodes of the permissionless public blockchain, a block header and a proof that the enroll transaction is included in the block header.

The enroll transaction can include a signature using a secret key of a public-private key pair corresponding to a permissionless blockchain public key corresponding to an account from which the cryptocurrency balance is transferred to the smart contract, and the transaction identification can be a hash of the enroll transaction.

The join request can include a signature using a secret key of a public-private key pair corresponding to the permissioned blockchain public key. The send request can also include a signature using a secret key of a public-private key pair corresponding to the permissioned blockchain public key.

A further embodiment of the present disclosure provides a non-transitory processor readable medium having stored thereon processor executable instructions for carrying out a method for executing cryptocurrency transactions on a permissioned blockchain. The cryptocurrency transactions involve cryptocurrencies of a permissionless public blockchain. The method includes instantiating a private smart contract on the permissioned blockchain and receiving, by the private smart contract, a join request including a transaction identification. The transaction identification identifies an enroll transaction involving a public smart contract deployed on the permissionless public blockchain. The enroll transaction identifies a permissioned blockchain public key being valid on the permissioned blockchain and transfers a cryptocurrency balance to the public smart contract. The method further includes verifying, by the private smart contract, that the enroll transaction was properly executed, crediting, by the private smart contract, an account corresponding to the permissioned blockchain public key with the cryptocurrency balance, and receiving, by the private smart contract, a send request. The send request identifies a second cryptocurrency balance and a second permissioned blockchain public key being valid on the permissioned blockchain. The method additionally includes transferring, by the private smart contract, the second cryptocurrency balance from the account corresponding to the permissioned blockchain public key to a second account corresponding to the second permissioned blockchain public key.

An additional embodiment of the present disclosure provides a system for carrying out cryptocurrency transactions on a permissioned blockchain. The cryptocurrency transactions involving cryptocurrencies of a permissionless public blockchain. The system includes processor circuitry configured to instantiate a private smart contract on the permissioned blockchain and execute the private smart contract. The private smart contract is configured to receive a join request including a transaction identification. The transaction identification identifies an enroll transaction involving a public smart contract deployed on the permissionless public blockchain, the enroll transaction identifying a permissioned blockchain public key being valid on the permissioned blockchain and transferring a cryptocurrency balance to the public smart contract. The private smart contract is further configured to verify that the enroll transaction was properly executed, credit an account corresponding to the permissioned blockchain public key with the cryptocurrency balance, and receive a send request identifying a second cryptocurrency balance and a second permissioned blockchain public key being valid on the permissioned blockchain. The private smart contract is also configured to transfer the second cryptocurrency balance from the account corresponding to the permissioned blockchain public key to a second account corresponding to the second permissioned blockchain public key.

An embodiment of the present disclosure provides a method comprising one or more of the following operations:

1. a setup operation, comprising:
a. deploying a smart contract S_{c} on a blockchain B_{c} with a native cryptocurrency, and a contract Sₚ on a private/permissioned blockchain Bₚ
   2. a join Bₚ operation, comprising:
a. Bₚ receiving a registration request to enroll user with public key Pk
b. S_{c} receiving an Enroll transaction containing some coins and a target public key where the coins should be transferred to on Bₚ
c. Sₚ receiving a Join transaction containing the transaction ID of an Enroll transaction on the blockchain B_{c}.
d. Sₚ using an SPV client to verify the transaction with ID as provided in the Join call, and, upon successful verification, crediting coins to the key provided in the Enroll transaction
   3. a normal operation, comprising:
a. Sₚ receiving Send transactions that send coins from one account on Bₚ to another
   4. a cash-out operation, comprising:
a. Sₚ receiving a Quit transaction that aims at terminating the account of the caller on Bₚ and sending the coins back on B_{c}
b. Bₚ generating a proof π containing the number of coins owned by the caller and the target key that should receive the coins on B_{c}
c. S_{c} receiving the proof π, verifying it, and, if successful, crediting the number of coins specified in the proof to the public key similarly specified in the proof

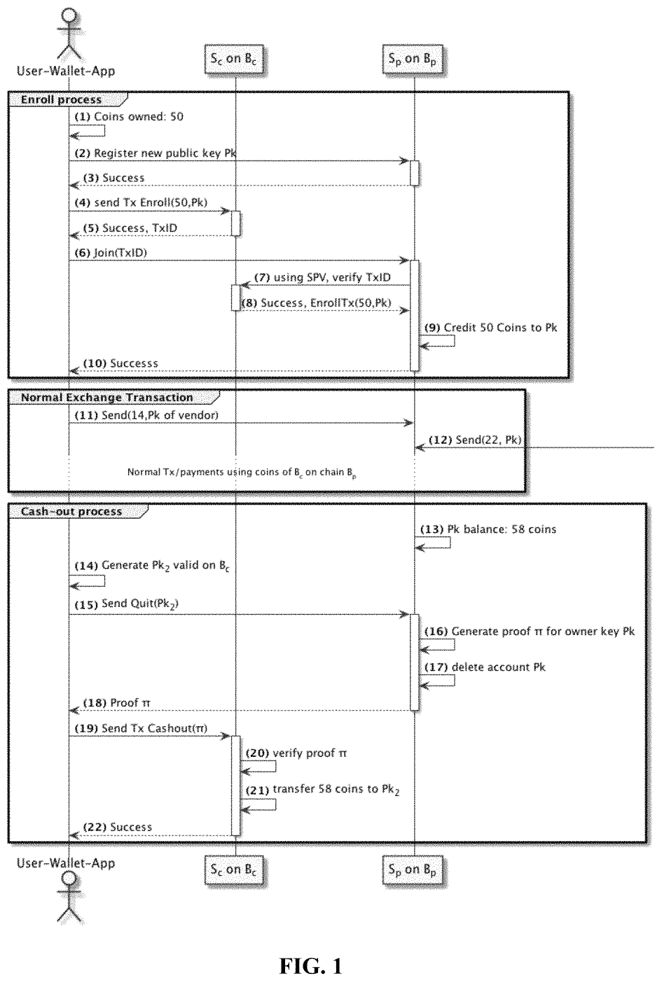

A workflow depicting an embodiment of the present disclosure is depicted in FIG. 1. The workflow includes the following:
1. A User-Wallet-App (i.e. user) first possesses a number of coins (e.g. 50) on the public chain B_{c}. Those coins are linked to a public key Pk_{B}_{_{c}} with a matching secret key Sk_{B}_{_{c}}.
2.-3. The user then registers a new public key Pk_{B}_{ₚ} (i.e. Pk) that is valid on the private chain Bₚ and generates a matching secret key Sk_{B}_{ₚ} (i.e. Sk) to form a form a public-private pair Pk_{B}_{ₚ}/Sk_{B}_{ₚ} that is valid on the private chain Bₚ. Since the private chain Bₚ is a permissioned chain, the user registers the key on the private chain Bₚ first.
4. The user then initiates a new enroll transaction on the public chain B_{c} with the following information:

$$T x < {s}_{c} , Enroll , 50 , {Pk}_{{B}_{p}} , s i {g}_{S {k}_{{B}_{c}}} >$$

Where s_{c} is the public smart contract to invoke, Enroll is the function to invoke on this smart contract, with the parameters 50 and Pk_{B}_{ₚ}, respectively being the number of coins to invoke and the public key they will be linked to. Finally,

$$s i {g}_{S {k}_{{B}_{c}}}$$

is the signature over all the previous field using the secret key Sk_{B}_{_{c}}.
5. The public smart contract s_{c}, after verifying that the transaction syntax and signature are correct, adds the number of coins invoked in the Enroll transaction to a single account (that sums the coins of all the users that implemented the Enroll function to transfer coins to the public smart contract s_{c}). It then successfully returns. The (e.g., mobile) app then retrieves the TxID as being Hash(Tx).
6. The user then sends a Join transaction using the TxID as a parameter to the private chain Bₚ:

$$T x < {s}_{p} , Join , TxID , s i {g}_{S {k}_{{B}_{p}}} >$$

Where sₚ is the private smart contract to invoke and Join is the function to invoke on this smart contract with a single parameter TxID. Finally,

$$s i {g}_{S {k}_{{B}_{p}}}$$

is the signature over the previous fields using the secret key Sk_{B}_{ₚ}.
7.-8. Using the SPV client, the private smart contract sₚ verifies that the Enroll transaction with the transaction identification TxID has been properly included in the public chain B_{c} and retrieves the fields “X coins” and “key” of the Enroll transaction.
9. The private smart contract sₚ adds the X coins (here, 50) to the public key Pk_{B}_{ₚ} as written in the Enroll transaction.
10. The enroll process is successful and the coins were transferred, on the public chain B_{c}, to the public smart contract s_{c} that corresponds to the private chain Bₚ. Until a user calls the Quit and Cashout transactions, the public smart contract s_{c} will store the coins securely without allowing anyone to withdraw them, as it only allows withdrawals through proofs π from the private chain Bₚ.
11.-12. Users can exchange coins on the private chain Bₚ through normal send( ) transactions. Users now benefits from low fees and quick processing.
13. The balance added at 9 is linked to the public key Pk_{B}_{ₚ} (e.g., the balance is 58 coins).
14. The user self-generates a new public key Pk_{B}_{_{c2}} (i.e. Pk₂) with a matching secret key Sk_{B}_{_{c2}} (i.e. Sk₂) that are valid on the public chain B_{c} or some other public chain B_{c2}. Here, the user does not need to enroll the public key as B_{c} (or B_{c2}) is an open/public blockchain. Where the user generates the new public key Pk_{B}_{_{c2}} with the matching secret key Sk_{B}_{_{c2}} that are valid on another public chain B_{c2}, the user can transfer coins held on a first public chain, i.e. B_{c}, to the public smart contract s_{c} on the first public chain (as described at 1-10 above), transact on the private chain Bₚ to exchange the coins held on the first public chain for coins held on the other public chain B_{c2} (as described at 11-12 above), and then provide a new public/private key pair Pk_{B}_{_{c2}}/Sk_{B}_{_{c2}} on the other public chain B_{c2} that can be used to withdraw the newly acquired coins of the second cryptocurrency from a second public smart contract s_{c2} on the second public chain B_{c2} (in an analogous manner to that described at 15-22 below). The private smart contract sₚ can interact with the second public smart contract s_{c2} on the second public chain B_{c2} in the same manner that the private smart contract sₚ interacts with the public smart contract s_{c} on the public chain B_{c} (as described at 15-22 below).
15. The user sends a quit transaction to the private chain Bₚ:

Tx<sₚ,quit,Pk₂,sigₛₖ>
Where sₚ is the private smart contract to invoke, quit is the function to invoke on this private smart contract, Pk_{B}_{_{c2}} is the single parameter that is used to inform where the coins should be sent, and finally, the signature

$$s i {g}_{S {k}_{{B}_{c 2}}}$$

over the previous field using the secret key Sk_{B}_{_{c2}}. As an alternative, the user can also use the public key Pk_{B}_{_{c}} with a matching secret key Sk_{B}_{_{c}} as the parameter used to inform where the coins should be sent and for the signature.
16. The private chain Bₚ generates the proof π with the following information:

π<Quit,nCoins,targetKey,sin_{quorum}>
Where Quit is the action being performed, nCoins is the number of coins previously owned by the key Pk_{B}_{ₚ} (i.e. 58 in this example), targetKey is the key where the coins should be sent (Pk_{B}_{_{c2}} or Pk_{B}_{_{c}} in our example), and sig_{quorum} is the signature over the previous fields by a valid quorum of the private chain Bₚ as explained herein.
17. Since the user wants to withdraw the coins on the public chain B_{c} or B_{c2}, the account on Bₚ is terminated and deleted. Alternatively, where the private smart contract sₚ allows a further function, e.g. Withdraw(coins, key), which allows a user to withdraw only a portion of their coin balance (indicated as an input to the Withdraw function) on the private chain Bₚ but otherwise performs the same functions as the Quit function, the account on the private chain Bₚ is not terminated and deleted.
18. The user receives the proof π.
19. The user sends the Cashout transaction to B_{c}:

Tx<s_{c},Cashout,π,sig>
Where s_{c} is the smart contract to invoke, Cashout is the function to invoke on this smart contract, π is the proof generated by the Quit function (or the Withdraw function, where provided for by the private smart contract sₚ) and sig is a signature over the previous field. In this case, the key used to sign the transaction does not matter, as it does not influence the evaluation of the transaction by the public smart contract s_{c}. It only needs to provide the fees needed to execute the function in the case the chain B_{c} (or B_{c2}) requires it.
20. The smart contract s_{c} verifies the proof by checking that the signature represents a quorum.
21. The smart contract s_{c} finally withdraws the number of coins nCoins from its local account and sends it to the key targetKey. In our example, this would be 58 coins sent to Pk_{B}_{_{c1}} or Pk_{B}_{_{c}}.
22. Upon successful return, the user has access to the coins directly on the public chain B_{c} again (or on the public chain B_{c2}) and can issue transactions normally on said public chain.

According to embodiments of the present disclosure, different BFT proof instantiations can be utilized, e.g. to account for the need to update BFT proof configuration parameters as a result of new users registering on the private chain Bₚ. In a normal quorum update and verification, the public smart contract s_{c} is initialized with the existing configuration of the BFT algorithm hardcoded in the contract. Proofs are then verified by ensuring that the number of signatures in π form a quorum.

In order to keep the public smart contract s_{c} updated, every time there is a change in the configuration of the BFT instance (i.e. new node added, node departed, node changed key, etc.), a configuration update is sent to the public smart contract s_{c} containing a list of key to remove from the configuration, and a list of key to add. Those configuration updates are signed by a quorum valid according to the old configuration, allowing the public smart contract s_{c} to be ensured that the updates are valid. The smart contract then keeps track of the currently valid list of peers by removing the keys to remove and adding the keys who joined. Configuration parameters such as total number of nodes (N) and minimum quorum size (Q) are updated similarly.

An advantage of embodiments of the present disclosure that use normal quorum update and verification is that only minimal trust is required, and higher efficiency is provided, particularly when nodes do not join and leave often.

According to alternative embodiments, an accumulator based quorum update can be implemented. In such a setup, the same configuration as for the “normal quorum update and verification” is kept, except that the configurations are updated using a cryptographic accumulator. Every time some nodes join or leave, a new accumulator containing the set of currently valid keys of all the nodes is created and sent to the public smart contract s_{c}. Similar to the previous configuration update, the accumulator is signed by a valid quorum from the previous configuration.

An advantage of embodiments of the present disclosure using the accumulator-based quorum update is that configuration updates become very cheap as the size of the transaction is constant (regardless of the number of keys changed).

In order to drastically reduce the size of proofs π sent to the smart contract S_{c}, a an embodiment of the present disclosure uses a trusted third party to verify proofs off-chain and sign the public smart contract s_{c} transaction in the case it is correct. In such a case, the public contract s_{c} is configured to recognize only a private key associated with the public key Pk_{sgx}. Since such a third party, if malicious, is able to withdraw all the funds held by the public smart contract s_{c}, proper behavior is enforced by having the key generated by a trusted execution environment (TEE), such as a software guard extension (SGX) enclave, where the key is generated by a secure enclave and the hardware security prevents misbehavior. The enclave then verifies the proofs π as described herein, and, if correct, signs the transaction in the stead of the quorum. This aspect drastically simplifies the public smart contract s_{c} as it now needs to accept transactions from Pk_{sgx} only, without any configuration change. In order to ensure availability and fairness, it is assumed that nodes of the BFT algorithm run an SGX proxy alongside. All the SGX proxies would share a single public key Pk_{sgx}, and a secret key Sk_{sgx}. This can be achieved by generating the key on one of the SGX enclaves, and then sharing it securely to all the other enclaves.

Here the security relies on the fact that it is hard to extract information from the SGX enclave, and that the enclave was implemented properly. In such a case, the enclave would securely verify that proofs π are valid with its knowledge of the BFT configuration and if correct, simply replace the list of signatures in π with a single signature using Sk_{sgx}.

Embodiments of the present disclosure leverage a simplified payment verification (SPV) mode from within a public smart contract to verify transactions of public blockchains.

Embodiments of the present disclosure exchange configuration updates and proofs of balance and proofs of consensus between a smart contract on a permissioned private chain and a smart contract on a permissionless public chain to free locked coins from the smart contract on the permissionless public chain upon reception of a proof from the permissioned private chain.

Embodiments of the present disclosure improve, e.g., private blockchains without a native currency. Aspects of the present disclosure make it possible to use widely accepted cryptocurrencies and tokens from public blockchains for payments or even other asset transactions in the private blockchain. Aspects of the present disclosure can be exploited in any blockchain use case that includes on-chain payments (which is the case with the majority of use cases). Furthermore, assets that have been tokenized (e.g., on Ethereum) can be transferred in transactions executed on private blockchains.

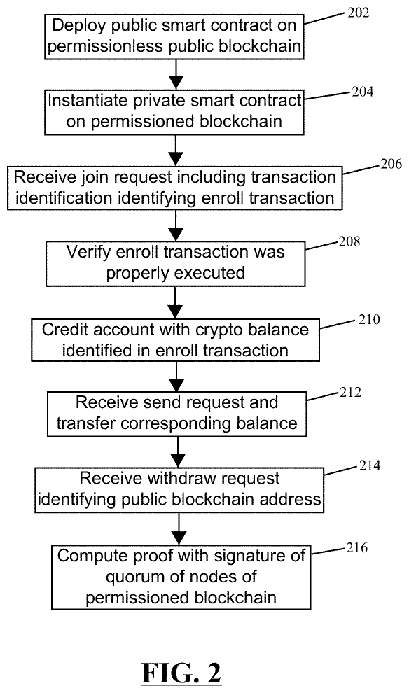

FIG. 2 illustrates a method, implemented by a permissioned private blockchain, for conducting delegated off-chain payments using cryptocurrencies of a permissionless public blockchain. At 202, a public smart contract is deployed on the permissionless public blockchain. At 204, a private smart contract is instantiated on the permissioned blockchain. At 206, the private smart contract receives a join request including a transaction identification. The transaction identification identifies an enroll transaction involving the public smart contract deployed on the permissionless public blockchain. The enroll transaction identifies a permissioned blockchain public key being valid on the permissioned blockchain. The enroll transaction also transfers a cryptocurrency balance to the public smart contract.

At 208, the private smart contract verifies that the enroll transaction was properly executed. At 210, the private smart contract credits an account corresponding to the permissioned blockchain public key with the cryptocurrency balance. At 212, the private smart contract receives a send request identifying a second cryptocurrency balance and a second permissioned blockchain public key being valid on the permissioned blockchain, and transfers the second cryptocurrency balance from the account corresponding to the permissioned blockchain public key to a second account corresponding to the second permissioned blockchain public key.

At 214, the private smart contract receives a withdraw request identifying a permissionless blockchain public key, the withdraw request including a signature using a secret key of a public-private key pair corresponding to the second permissioned blockchain public key. At 216, the permissioned blockchain computes a proof including a third cryptocurrency balance corresponding to the amount of cryptocurrency then held by the second permissioned blockchain public key, the permissionless blockchain public key, and a signature of a valid quorum of nodes of the permissioned blockchain.

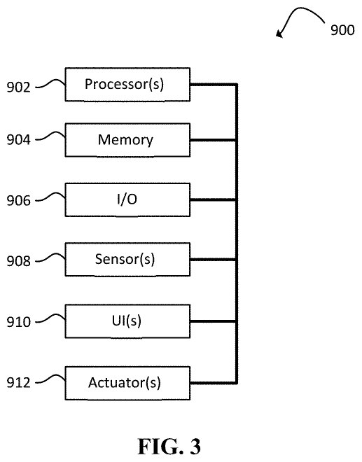

Referring to FIG. 3, a processing system 900 can include processing circuitry 902, memory 904, one or more input/output devices 906, one or more sensors 908, one or more user interfaces 910, and one or more actuators 912. Processing system 900 can be representative of each computing system disclosed herein.

Processing circuitry 902 can include one or more distinct processors, each having one or more cores. Each of the distinct processors can have the same or different structure. Processing circuitry 902 can include one or more central processing units (CPUs), one or more graphics processing units (GPUs), circuitry (e.g., application specific integrated circuits (ASICs)), digital signal processors (DSPs), and the like. Processing circuitry 902 can be mounted to a common substrate or to multiple different substrates.

Processing circuitry 902 is configured to perform a certain function, method, or operation (e.g., are configured to provide for performance of a function, method, or operation) at least when one of the processing circuitry is capable of performing operations embodying the function, method, or operation. Processing circuitry 902 can perform operations embodying the function, method, or operation by, for example, executing code (e.g., interpreting scripts) stored on memory 904 and/or trafficking data through one or more ASICs. Processing circuitry 902, and thus processing system 900, can be configured to perform, automatically, any and all functions, methods, and operations disclosed herein. Therefore, processing system 900 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 900 can be configured to perform task “X”. Processing system 900 is configured to perform a function, method, or operation at least when processing circuitry 902 are configured to do the same.

Memory 904 can include volatile memory, non-volatile memory, and any other medium capable of storing data. Each of the volatile memory, non-volatile memory, and any other type of memory can include multiple different memory devices, located at multiple distinct locations and each having a different structure. Memory 904 can include remotely hosted (e.g., cloud) storage.

Examples of memory 904 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 904.

Input-output devices 906 can include any component for trafficking data such as ports, antennas (i.e., transceivers), printed conductive paths, and the like. Input-output devices 906 can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices 906 can include wired and/or wireless communication pathways.

Sensors 908 can capture physical measurements of environment and report the same to processors 902. User interface 910 can include displays, physical buttons, speakers, microphones, keyboards, and the like. Actuators 912 can enable processors 902 to control mechanical forces.

Processing system 900 can be distributed. For example, some components of processing system 900 can reside in a remote hosted network service (e.g., a cloud computing environment) while other components of processing system 900 can reside in a local computing system. Processing system 900 can have a modular design where certain modules include a plurality of the features/functions shown in FIG. 9. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the present disclosure, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for securing a cryptocurrency transaction on a permissioned blockchain, the cryptocurrency transaction involving cryptocurrencies of a permissionless public blockchain, the method comprising:
performing, by a permissioned blockchain processing circuitry:
receiving a join request including a transaction identification, the transaction identification identifying an enroll transaction involving a public smart contract deployed on the permissionless public blockchain, the enroll transaction identifying a permissioned blockchain public key being valid on the permissioned blockchain and transferring a cryptocurrency balance to the public smart contract;
verifying that the enroll transaction was properly executed;
crediting an account corresponding to the permissioned blockchain public key with the cryptocurrency balance; and
receiving a send request identifying a second cryptocurrency balance and a second permissioned blockchain public key being valid on the permissioned blockchain; and
transferring the second cryptocurrency balance from the account corresponding to the permissioned blockchain public key to a second account corresponding to the second permissioned blockchain public key.

2. The method according to claim 1, further comprising deploying, by the permissioned blockchain, the public smart contract in the permissionless public blockchain.

3. The method according to claim 1, wherein the verifying that the enroll transaction was properly executed comprises invoking a simplified payment verification (SPV) client to retrieve information corresponding to the transaction identification.

4. The method according to claim 3, wherein the SPV client is configured to request, from each of multiple public nodes of the permissionless public blockchain, a block header and a proof that the enroll transaction is included in the block header.

5. The method according to claim 1, wherein the enroll transaction includes a signature using a secret key of a public-private key pair corresponding to a permissionless blockchain public key corresponding to an account from which the cryptocurrency balance is transferred to the smart contract, and
wherein the transaction identification is a hash of the enroll transaction.

6. The method according to claim 1, wherein the join request includes a signature using a secret key of a public-private key pair corresponding to the permissioned blockchain public key.

7. The method according to claim 1, wherein the send request includes a signature using a secret key of a public-private key pair corresponding to the permissioned blockchain public key.

8. The method according to claim 1, further comprising performing, by the permissioned blockchain processing circuitry:
receiving a withdraw request identifying a permissionless blockchain public key, the withdraw request including a signature using a secret key of a public-private key pair corresponding to the second permissioned blockchain public key; and
computing a proof including a third cryptocurrency balance, the permissionless blockchain public key, and a signature of a valid quorum of nodes of the permissioned blockchain.

9. The method according to claim 5, wherein the proof is a Byzantine fault tolerance (BFT) proof.

10. The method according to claim 9, wherein the public smart contract is configured to evaluate the validity of the BFT proof.

11. The method according to claim 7, further comprising performing, by the permissioned blockchain processing circuitry:
transmitting, to the public smart contract, BFT configuration parameters, the BFT configuration parameters being used by the public smart contract to evaluate the validity of the BFT proof.

12. The method according to claim 8, further comprising performing, by the permissioned blockchain processing circuitry:
updating the BFT configuration parameters in response to an increase or decrease in a total number of nodes of the permissioned blockchain and/or a number of nodes of the permissioned blockchain required for a quorum.

13. The method according to claim 9, wherein the updating the BFT configuration parameters includes transmitting, to the public smart contract, a cryptographic accumulator that includes a set of currently valid keys of all nodes of the permissioned blockchain, wherein the cryptographic accumulator is signed by a valid quorum of nodes of a previous configuration of the permissioned blockchain.

14. The method according to claim 9, wherein a trusted execution environment (TEE) is configured to evaluate the validity of the BFT proof and wherein the public smart contract is configured to verify the enroll transaction.

15. A non-transitory processor readable medium having stored thereon processor executable instructions for securing a cryptocurrency transaction on a permissioned blockchain, the cryptocurrency transaction involving cryptocurrencies of a permissionless public blockchain, the method comprising:
receiving a join request including a transaction identification, the transaction identification identifying an enroll transaction involving a public smart contract deployed on the permissionless public blockchain, the enroll transaction identifying a permissioned blockchain public key being valid on the permissioned blockchain and transferring a cryptocurrency balance to the public smart contract;
verifying that the enroll transaction was properly executed;
crediting an account corresponding to the permissioned blockchain public key with the cryptocurrency balance; and
receiving a send request identifying a second cryptocurrency balance and a second permissioned blockchain public key being valid on the permissioned blockchain; and
transferring the second cryptocurrency balance from the account corresponding to the permissioned blockchain public key to a second account corresponding to the second permissioned blockchain public key.

16. A system for securing a cryptocurrency transaction on a permissioned blockchain, the cryptocurrency transaction involving cryptocurrencies of a permissionless public blockchain, the system comprising:
processor circuitry configured to:
receive a join request including a transaction identification, the transaction identification identifying an enroll transaction involving a public smart contract deployed on the permissionless public blockchain, the enroll transaction identifying a permissioned blockchain public key being valid on the permissioned blockchain and transferring a cryptocurrency balance to the public smart contract;
verify that the enroll transaction was properly executed;
credit an account corresponding to the permissioned blockchain public key with the cryptocurrency balance;
receive a send request identifying a second cryptocurrency balance and a second permissioned blockchain public key being valid on the permissioned blockchain; and
transfer the second cryptocurrency balance from the account corresponding to the permissioned blockchain public key to a second account corresponding to the second permissioned blockchain public key.
